(19) United States
(12) Patent Application Publication
(10) Pub. No.: US 2009/0129969 A1
(43) Pub. Date: May 21, 2009

(54) Wire based on zinc and aluminum and its use in thermal spraying for corrosion protection

(75) Inventors: Jochen Spriestersbach, Marl (DE); Peter Staubwasser, Ratingen (DE)

Correspondence Address: JACOBSON HOLMAN PLLC, 400 SEVENTH STREET N.W., SUITE 600, WASHINGTON, DC, 20004, US

(73) Assignee: Grillo-Werke AG.

(21) Appl. No.: 12/285,221

(22) Filed: Sep. 30, 2008

Related U.S. Application Data
(63) Continuation of application No. 10/232,816, filed on Sep. 3, 2002, now abandoned.
Application No. 10/232,816 is a continuation of application No. 09/656,423, filed on Sep. 6, 2000, now abandoned.

(51) Int. Cl. C22C 18/04; B32B 15/04

(52) U.S. Cl. 420/520; 420/514; 428/655

(57) ABSTRACT

The wire based on zinc and aluminum contains from 8 to 33% by weight of aluminum and up to 500 ppm of indium, in addition to zinc and the usual impurities. This wire is suitable for thermal spraying for corrosion protection, especially corrosion protection against high atmospheric humidity and high chloride ion concentrations according to DIN 50021-ss.

The present invention relates to a wire based on zinc and aluminum which can be used in thermal spraying for corrosion protection, especially for corrosion protection against high atmospheric humidity and high chloride ion concentrations, e.g., in marine environments, thawing salt etc.

DE 30 07 850 C2 describes the use of a zinc alloy as a powder for mechanical cladding, wherein an alloy of zinc and one or more alloying additions is to be used, such as from 0.1 to 60% of aluminum, up to 5% of nickel, up to 3% of magnesium, up to 3% of copper, up to 2% of silicon, up to 1.5% of titanium, up to 1% of antimony, up to 1% of silver, up to 0.5% of chromium, 0.5% of beryllium, up to 0.1% of calcium, up to 0.1% of cobalt, up to 0.1% of sodium, up to 0.1% of potassium, 0.1% of indium, up to 0.05% of lithium, 0.05% of strontium, respectively based on the total weight of the alloy except the weight of contaminations. In mechanical cladding with a metal powder, this powder is mechanically applied to the substrate to form a layer of 10 μm. Roll-bonded cladding, also using aluminum powder, is described, for example, in Aluminium-Taschenbuch, 13th edition, 1974, page 927, paragraphs 1 and 2.

Also in the method according to DE 30 07 850 C2, the parts to be mechanically clad, after degreasing, are subjected to a surface cleaning and conditioning and arc coating to form a coating layer. The thus prepared coating layers are additionally subjected to a chromate treatment. This method is fundamentally different from thermal spraying using wires which are employed in wire flame spraying or wire arc spraying. Wire flame spraying and wire arc spraying can also be employed later for finished building components or in situ for bridges, scaffolds, cranes etc. In contrast, roll-bonded cladding cannot be performed later.

DD-PS 4 822 describes that it is possible to process zinc-aluminum alloys in the range of eutectoid decay by annealing followed by quenching to yield articles having a high plasticity. From this material, a wire can be prepared by extruding from an alloy of 80% zinc and 20% aluminum.

To date, wires for thermal spraying have consisted of either high-purity zinc, an alloy of only zinc/aluminum with 15% by weight of aluminum, or aluminum with 5% by weight of magnesium.

One drawback of thermally sprayed surfaces of high-purity zinc or zinc with 15% by weight of aluminum is that they corrode fast and more severely than aluminum with 5% magnesium under the above mentioned conditions. Therefore, additional protective measures, such as paint coats, are necessary for zinc and zinc/aluminum coatings under moisture and chloride exposure.

In the condensed water test according to DIN 50018-KFW 0.2 s, a severe corrosion of high-purity zinc is observed while zinc with 15% of aluminum exhibits a clearly more favorable performance.

But also coatings of aluminum with 5% magnesium, which show high stability towards high moisture contents and high chloride ion levels, corrode more severely than zinc with 15% by weight of aluminum in the condensed water test.

Thus, it has been the object of the invention to provide a zinc wire based on zinc and aluminum which exhibits a high corrosion resistance both in the condensed water test and in the salt-spray test according to DIN 50021 and thus, if possible, exhibits the same corrosion resistance as aluminum with 5% magnesium, also against high atmospheric humidity and high chloride ion levels, i.e., the salt-spray test according to DIN 50021, or even a higher corrosion resistance.

This object has now been achieved by a wire based on zinc and aluminum containing from 8 to 33% by weight of aluminum and up to 500 ppm of indium, in addition to zinc and the usual impurities. Preferably, the wire contains from 10 to 24% by weight of aluminum and from 10 to 300 ppm of indium.

Even more preferably, the wire contains from 15 to 22% by weight of aluminum and from 20 to 200 ppm of indium.

Among the numerous Examples of DE 30 07 850 C2 are three Examples in which 0.1% indium was employed, namely Examples 41, 62 and 74. However, such a high amount of indium results in severe brittleness and poor processibility of the wires. Therefore, according to the invention, the amount of indium is limited to a maximum of 500 ppm, and preferably, only from 10 to 300 ppm of indium is used. A zinc-aluminum wire with 0.08% of indium already becomes totally brittle in the condensed water test.

Further, from DE 30 07 850 C2, it can be seen that the addition of 0.1% by weight of indium to a zinc powder with 5% aluminum has not resulted in an optimum corrosion resistance by far. Thus, it was surely not obvious to process an alloy comprising less indium into a wire in order to obtain a material which has optimum properties if processed from a wire into a corrosion protection which can be applied later by wire flame spraying or arc spraying.

Optimum results are achieved when the content of usual impurities is kept as low as possible. In particular, as little as possible copper, iron and lead should be contained in the alloy.

In principle, all zinc grades according to EN 1179 can be employed as a starting material for the wire, zinc grades Z1 to Z4 being preferred because they contain clearly less lead, iron and copper than the maximum value desired according to the invention.

As the alloy component aluminum, the grades according to EN 576 meeting the purity requirements demanded can be employed in principle.

The wire according to the invention can be prepared by usual methods, namely by casting the liquid alloy as a cast strand followed by rolling and drawing. For these methods, alloys comprising only from 10 to 24% by weight of aluminum are preferred, on the other hand, since alloys having a higher aluminum content are more difficult to process.

The wire according to the invention can be employed for thermal spraying in the conventional way, for example, by wire flame spraying or wire arc spraying. These methods are mainly distinguished by different process temperatures and thus by different coating efficiencies.

From the following Examples and Comparative Examples, it can be seen that the novel wire has clearly improved properties, and its overall properties are superior to those found in the whole prior art.

### EXAMPLE 1

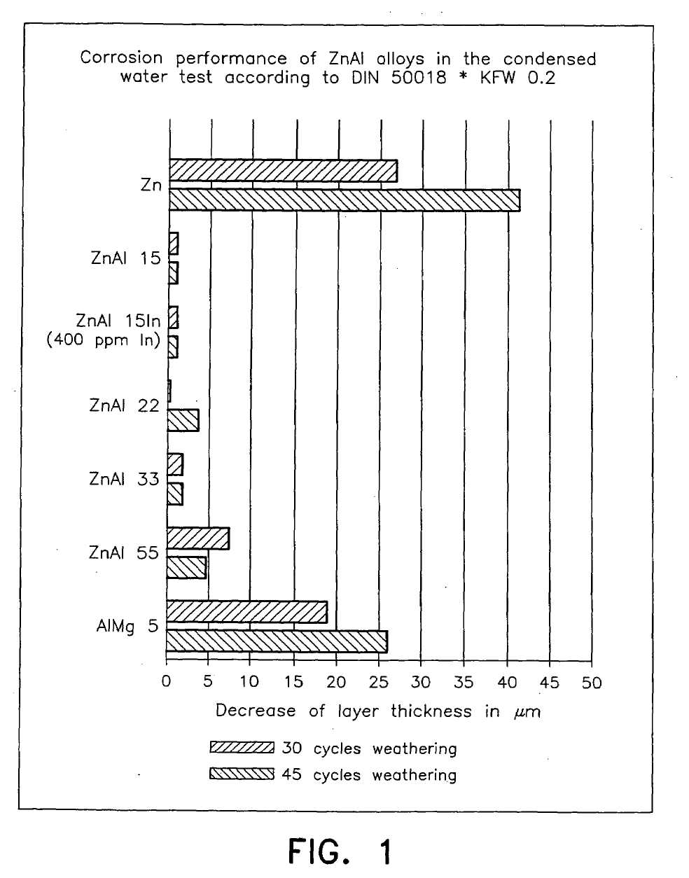

From the accompanying FIG. 1, it can be seen that pure zinc exhibits the poorest values in the condensed water test according to DIN 50018-KFW 0.2 s, but aluminum with 5% by weight of magnesium also exhibits severe corrosion. The conventional wire made of zinc with 15% by weight of aluminum exhibits good values. By the addition of 400 ppm of indium, its performance is neither improved nor deteriorated. Zinc wires with 22%, 33% or 55% by weight of aluminum already exhibit poorer values. Zinc alloys with more than 25% by weight of aluminum are increasingly difficult to process into a wire.

### EXAMPLE 2

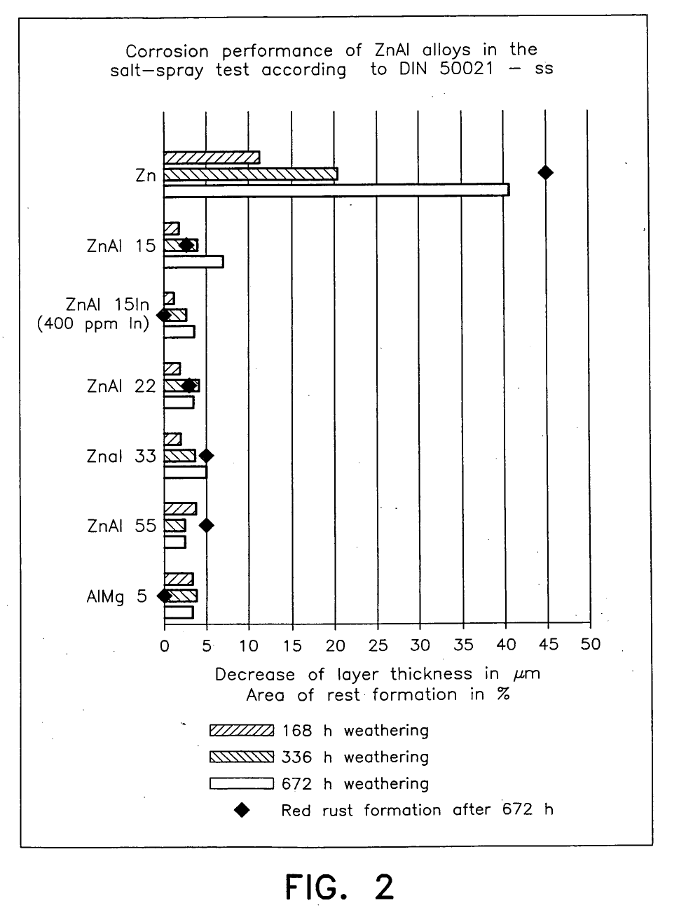

The same wires as in Example 1 are subjected to the salt-spray test according to DIN 50021-ss. The results are shown in FIG. 2. It can be seen that pure zinc again provides the poorest results and, in addition, shows formation of red rust. In contrast, aluminum with 5% magnesium, which has been selected for such conditions to date, shows clearly better values and no formation of red rust.

In comparison, zinc with 15% aluminum has a substantially lower corrosion resistance and exhibits formation of red rust. By adding more aluminum to the zinc, namely 22%, 33% or 55%, although the corrosion performance is clearly improved over that of only 15% aluminum, formation of red rust is still observed. Only the addition of 400 ppm of indium to a zinc/aluminum alloy with 15% aluminum achieves results which are equivalent or even better than those achieved with aluminum to which 5% magnesium is added. Especially for short weathering times, this alloy is even superior to aluminum with 5% magnesium.

### EXAMPLE 3

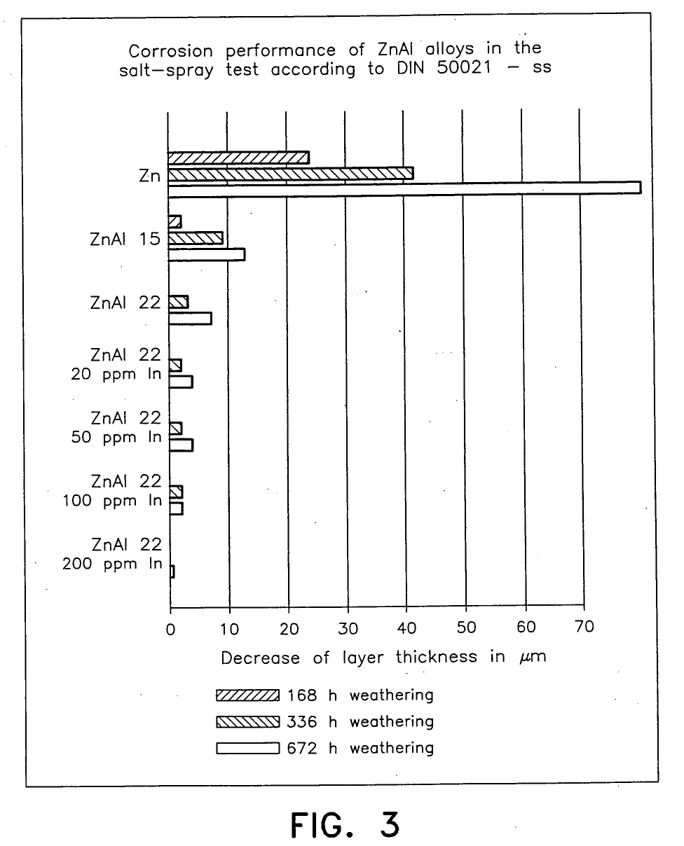

Wires based on zinc and aluminum containing 22% by weight of aluminum and increasing amounts of indium are subjected to a salt-spray test according to DIN 50021-ss. The results are summarized in FIG. 3, with high-purity zinc and zinc with 15% aluminum again being included for comparison. It can be seen that 20 ppm of indium already results in a significant improvement of the corrosion performance, and increasing amounts of indium can further improve the corrosion performance. Amounts of over 500 ppm of indium are neither reasonable in terms of cost, nor do they result in a further improvement of properties. In addition, it is to be noted that the addition of larger amounts of indium deteriorates the processibility of the alloy into a wire.

### EXAMPLE 4

Preliminary examinations with different purity grades of zinc and aluminum revealed that impurities of more than 0.1% by weight of copper and more than 0.1% by weight of iron, in particular, result in deteriorated properties and especially enhance intercrystalline corrosion, while more than 1% by weight of lead results in deteriorated mechanical properties.

1-5. (canceled)

6. A zinc alloy wire comprising
zinc alloyed with
aluminum, at 8 to 33% by weight, and
indium, at 10 to 500 ppm,
wherein the zinc alloy wire is useful in thermal spraying.

7. The zinc alloy wire according to claim 6, wherein
the aluminum is present at 10 to 24% by weight and
the indium is present at 10 to 300 ppm.

8. The zinc alloy wire according to claim 6, wherein,
the aluminum is present at 15 to 22% by weight and
the indium is present at 20 to 200 ppm.

9. The zinc alloy wire according to claim 6 having
less than 0.1% by weight copper,
less than 0.1% by weight iron, and
less than 1% by weight lead.

10. An article comprising a corrodible metal having a zinc alloy coating, wherein the zinc alloy coating includes
zinc alloyed with
aluminum, at 8 to 33% by weight, and
indium, at 10 to 500 ppm,
produced by thermal spraying of the zinc alloy wire of claim 6.

11. The article according to claim 10, wherein
the aluminum is present at 10 to 24% by weight and
the indium is present at 10 to 300 ppm.

12. The article according to claim 10 having
less than 0.1% by weight copper,
less than 0.1% by weight iron, and
less than 1% by weight lead.

13. The article according to claim 10, wherein,
the aluminum is present at 15 to 22% by weight and
the indium is present at 20 to 200 ppm.

14. An article comprising a metal having a zinc alloy coating, wherein the zinc alloy coating includes
zinc alloyed with
aluminum, at 8 to 33% by weight, and
indium, at 10 to 500 ppm.

15. The article according to claim 14, wherein
the aluminum is present at 10 to 24% by weight and
the indium is present at 10 to 300 ppm.

16. The article according to claim 14 having
less than 0.1% by weight copper,
less than 0.1% by weight iron, and
less than 1% by weight lead.

17. The article according to claim 14, wherein,
the aluminum is present at 15 to 22% by weight and
the indium is present at 20 to 200 ppm.
